(19) United States
(12) Patent Application Publication
(10) Pub. No.: US 2013/0188265 A1
(43) Pub. Date: Jul. 25, 2013

(54) High-Aperture Wide-Angle Lens

(71) Applicants: Hildegard Ebbesmeier, Schweppenhausen (DE); Thomas Steinich, Heilbronn (DE)

(72) Inventors: Hildegard Ebbesmeier, Schweppenhausen (DE); Thomas Steinich, Heilbronn (DE)

(73) Assignee: JOS. SCHNEIDER OPTISCHE WERKE GMBH, Bad Kreuznach (DE)

(21) Appl. No.: 13/818,096

(22) PCT Filed: Aug. 11, 2011
(86) PCT No.: PCT/EP2011/063863

§ 371 Date: Feb. 20, 2013

(30) Foreign Application Priority Data
Aug. 20, 2010 (DE) 102010035034.6

(51) Int. Cl. G02B 13/04

(52) U.S. Cl. CPC G02B 13/04
USPC 359/715

(57) ABSTRACT

A high-aperture wide-angle lens for digital image acquisition, comprising five lens elements, as viewed from the object side, i.e. from the left, a first, negative meniscus lens element, a second, positive lens element, a third, positive lens element, a fourth, negative lens element and a fifth, positive meniscus lens element. A diaphragm is arranged between the second lens element and the third lens element. At least three surfaces upstream of the diaphragm and three surfaces downstream of the diaphragm are embodied as aspherical surface. However, further surfaces can also have an aspherical design. On account of its extremely compact design and its outstanding optical properties, the proposed high-aperture wide-angle lens is suitable as an interchangeable lens for so-called “hybrid cameras”.

### FIELD OF THE INVENTION

The invention relates to a high-aperture wide-angle lens for digital image acquisition for photographic and industrial applications.

### PRIOR ART

Besides digital reflex cameras, there is increasing interest in digital cameras without mirrors, but having approximately comparable properties with regard to the imaging quality and accessories, in particular with regard to the possibility of being able to use interchangeable lenses for specific tasks.

Dispensing with the mirror primarily affords a size advantage over reflex cameras for the systems. The model sizes of mirrorless cameras are already approaching those of large compact cameras.

Digital cameras having interchangeable lenses, but without mirrors, are often designated as “hybrid camera”. Interchangeable lenses having as compact a design as possible are also required, inter alia, in order to realize various specific uses of such cameras.

A wide-angle lens for digital image acquisition is described in U.S. Pat. No. 7,239,457 B2, for example. This wide-angle lens is suitable for acquisition with a half field angle in the range of between 40° and 50°. It has five or six lens elements, wherein the third and fourth lens elements are cemented to one another. One application-conforming property of the lens described is, for example the beam path downstream of the front lens element, said beam path being deflected by 90° by means of a prism. As a result, it is not suitable as an interchangeable lens for hybrid cameras. Furthermore, it has a very long total structural length.

Traditional wide-angle retrofocused lenses, such as in e.g. U.S. Pat. No. 5,631,780, consist of a multiplicity of spherical lens elements, here e.g. 10 lens elements, and have a structural length of approximately 70 to 100 mm. Aspherical surfaces are used only to a very small extent, here for example only two surfaces.

The document U.S. 2009/0009887 A1 describes, for example, a wide-angle lens comprising only five lens elements, wherein, as viewed from the object side, the third and fourth lens elements form a doublet. In this case, at least one of the five lens elements has an aspherical surface on the object side and at least one of the five lens elements has an aspherical surface on the image side. Moreover, in total at least three of the surfaces of the five lens elements are embodied in an aspherical fashion.

Another document (U.S. 2003/0174410 A1) discloses a wide-angle lens (having a fixed focal length) which likewise comprises five lens elements, constituting four lens element groups. Here, too, the third and fourth lens elements, as viewed from the object side, form a doublet. All lens element groups, with the exception of the doublet, are individual lens elements, wherein each of the individual lens elements has an aspherical surface.

### Problem

The problem addressed by the invention is that of specifying a high-aperture wide-angle lens which is distinguished by a very compact design and by a very good imaging quality.

### SUMMARY OF THE INVENTION

This problem is solved by the inventions comprising the features of the independent claim. Advantageous developments of the inventions are characterized in the dependent claims. The wording of all of the claims is hereby incorporated by reference in the content of this description.

The invention relates to a wide-angle lens for digital image acquisition, comprising the following elements in the stated order, as viewed from the object side:
a) a first, negative meniscus lens element, wherein the convex surface of the meniscus lens element faces the object side;
b) a second, positive lens element, wherein the more greatly curved convex surface of the lens element faces the object side;
c) a diaphragm;
d) a third, positive lens element,
wherein the more greatly curved convex surface of the lens element faces away from the object side;
e) a fourth, negative lens element;
f) wherein the third, positive lens element and the fourth, negative lens element are cemented to one another; and
g) a fifth, positive meniscus lens element, wherein the convex surface of the meniscus lens element faces away from the object side;
h) wherein the wide-angle lens has no further lens elements;
wherein the surface of the second lens element facing the object has an aspherical surface;
wherein at least three lens element surfaces on the object side upstream of the diaphragm and at least three lens element surfaces on the image side downstream of the diaphragm are embodied as aspherical surface; and P1 wherein the refractive indexes n_{d} and Abbe numbers v_{d} of the lens element materials fulfill the conditions according to the table below, wherein all these conditions must be fulfilled simultaneously:

| | n_{d} | ν_{d} |
|---|---|---|
| 1st Lens | ≧1.8 | ≧40 |
| element | | |
| 2nd Lens | ≧1.8 | ≦30 |
| element | | |
| 3rd Lens | ≧1.8 | ≧45 |
| element | | |
| 4th Lens | ≧1.8 | ≦30 |
| element | | |
| 5th Lens | ≧1.5 | ≧55 |
| element | | |

, and
wherein the focal length of the first lens element has a value in the range of −1.0 to −1.2 times the total focal length of the wide-angle lens.

The wide-angle lens proposed is suitable for use in conjunction with image sensors up to an image circle diameter of 30 mm. In particular, they can be used in the photographic sector for APS-C (“Advanced Photo System Classic”) sensors and Micro Four Thirds sensors. The sensor size in APS-C is approximately 23.6×15.8 mm (which corresponds approximately to an aspect ratio of 3:2).

The proposed lens having a focal length of 16 mm and f-numbers of 2.8 and 2.2 is suitable for image circle diameters of up to 30 mm. The lens having a focal length of 12 mm and an f-number of 2.4 is provided for image circle diameters of up to 21.7 mm.

The object-side field angle of the lenses presented is greater than 80°; in particular, it is 85°. The significantly smaller image-side angle (principal ray angle that is incident on the chip plane) is a maximum of 20° and is necessary when using sensors with microlens elements in order to avoid loss of brightness.

The choice of glass types having higher refractive indexes (n_{d}1.8) for the first four lens elements fosters the attainment of an extremely compact overall system whilst at the same time maintaining the very good correction state (which corresponds to a high imaging performance).

Due to its extremely compact design and its outstanding optical properties, the high-aperture wide-angle lens proposed is, in particular, also suitable as an interchangeable lens for the so-called “hybrid cameras”.

In one advantageous development of the lens, the second, positive lens element and/or the third, positive lens element and/or the fourth, negative lens element of the lens are/is a meniscus lens element.
a) It is also advantageous that focusing of the image can be effected by shifting the entire lens along the optical axis, wherein the air clearances between the lens elements of the lens remain constant, and only the distance between the last surface of the fifth lens element and the image sensor is varied.

Focusing to different distances can be effected not only by the above mentioned overall shifting of the lens but additionally by varying the first air clearance downstream of the diaphragm, i.e. the distance between the diaphragm and the third, positive lens element. The latter makes possible an optimum imaging performance over a large range of imaging scales.

The air clearance downstream of the first lens element should be at least 0.6 times the focal length of the lens, while the vertex focal length downstream of the last lens element surface in the image-side direction should be at least 1.25 times the focal length of the lens.

It is also advantageous if the fourth lens element is a negative meniscus lens element, wherein the concave surface of the lens element faces the object side.

It is also advantageous if the first lens element has two aspherical surfaces. This serves for correcting distortion, astigmatism and image field curvature.

It is likewise advantageous if the fifth lens element has two aspherical surfaces. This serves for correcting field-dependent image aberrations and reduces the image-side field angle in comparison with the object-side field angle.

The object-side surface of the second lens element should advantageously be embodied as an asphere in order to ensure the correction of the spherical aberration. An additional aspherical surface on the image-side surface is expedient in order to achieve maximum apertures higher than k=2.8 (e.g. k=2.2).

It is also advantageous if the object-side surface of the third lens element has an aspherical surface. This serves for correcting pupil-dependent image aberrations.

In a further advantageous embodiment, it can be advantageous for the ratio of the Abbe number of the third lens element to the Abbe number of the fourth lens element to be a value greater than or equal to 1.5.

Further details and features are evident from the following description of preferred exemplary embodiments in conjunction with the dependent claims. In this case, the respective features may be realized by themselves or as a plurality in combination with one another. The possibilities for solving the problem are not restricted to the exemplary embodiments. Thus, for example, range indications always encompass all intermediate values—not stated—and all conceivable sub-intervals.

The exemplary embodiments are illustrated schematically in the figures. Identical reference numerals in the individual figures in this case designate elements which are identical or functionally identical or correspond to one another with regard to their functions.

In the Drawing

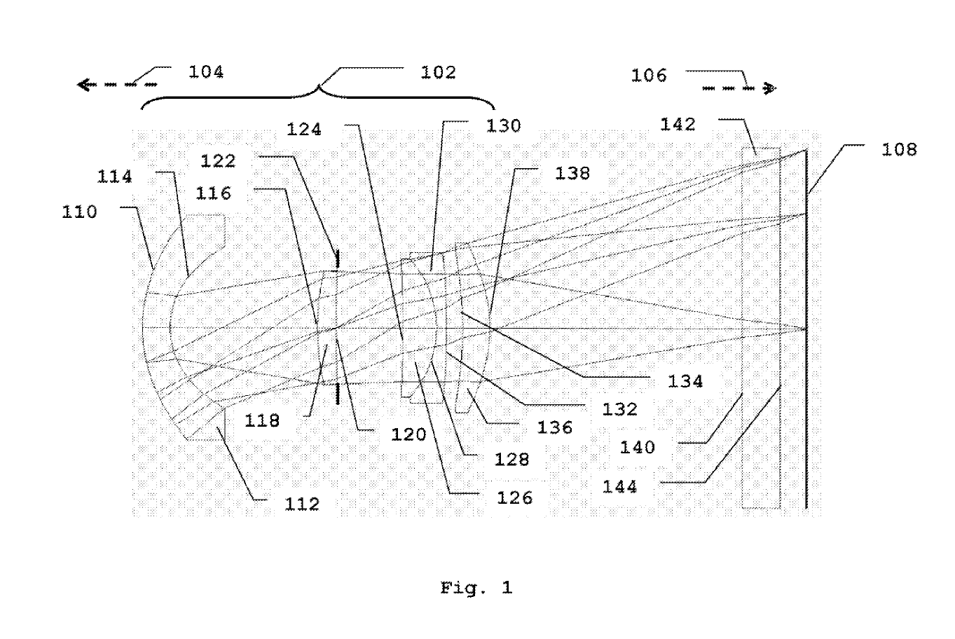

FIG. 1 shows a schematic illustration of an optical system with an exemplary embodiment of the lens element arrangement of the high-aperture wide-angle lens;

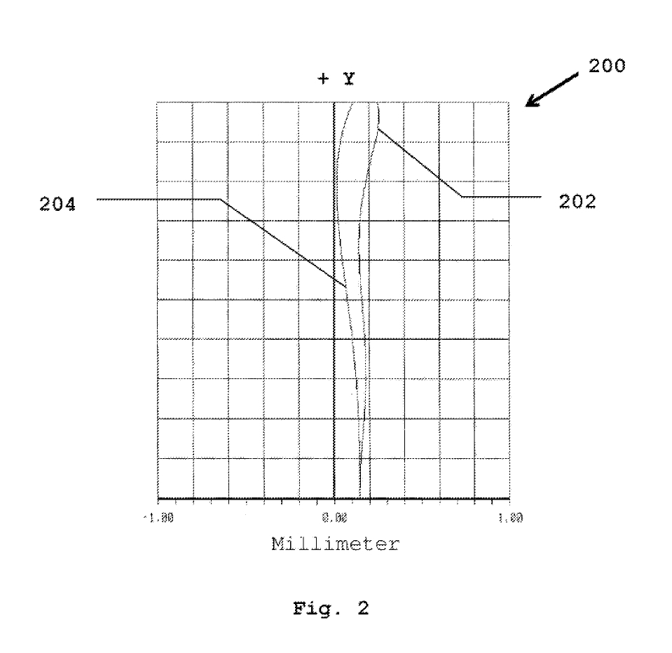

FIG. 2 shows a graphical illustration of the image field curvature of a wide-angle lens in accordance with FIG. 1 with a focal length of 16 mm and an f-number of k=2.8;

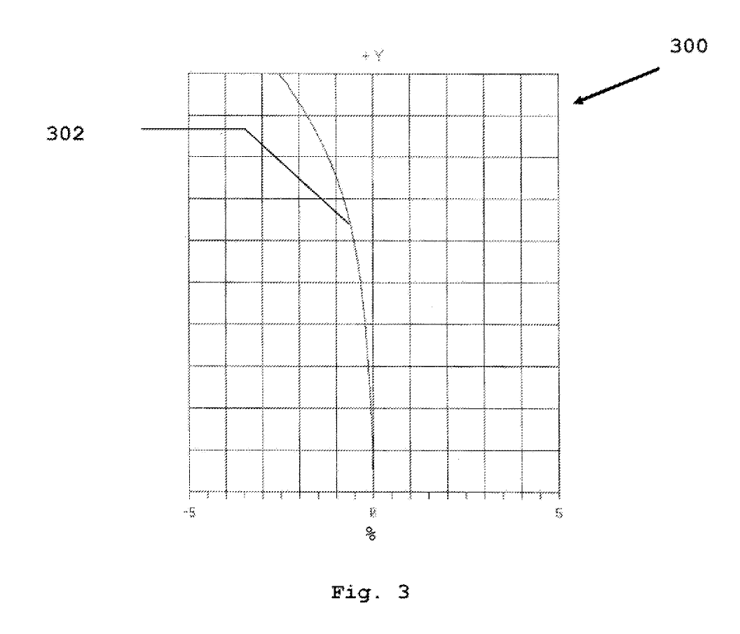

FIG. 3 shows a graphical illustration of the distortion of a wide-angle lens in accordance with FIG. 1 with a focal length of 16 mm and an f-number of k=2.8;

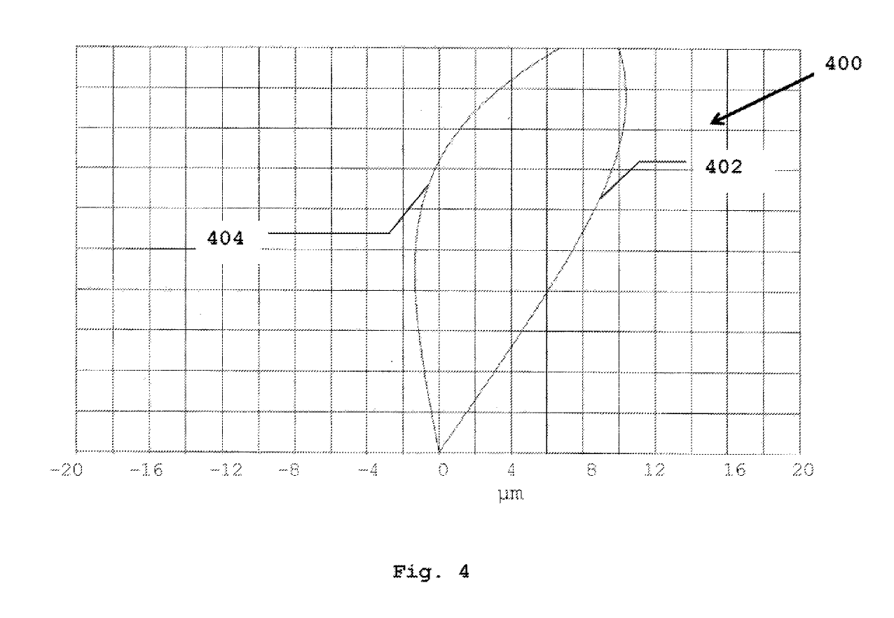

FIG. 4 shows a graphical illustration of the lateral chromatic aberration of a wide-angle lens in accordance with FIG. 1 with a focal length of 16 mm and an f-number of k=2.8;

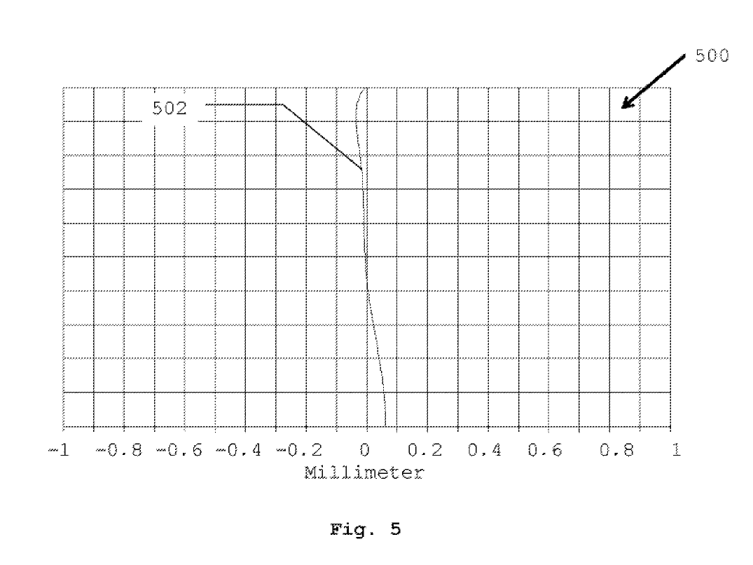

FIG. 5 shows a graphical illustration of the spherical aberration of a wide-angle lens in accordance with FIG. 1 with a focal length of 16 mm and an f-number of k=2.8;

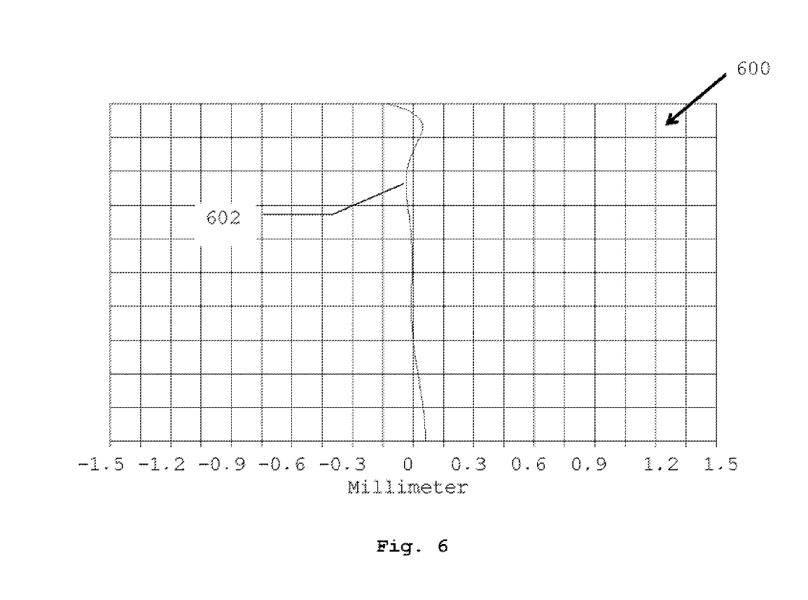

FIG. 6 shows a graphical illustration of the spherical aberration of a wide-angle lens in accordance with FIG. 1 with a focal length of 16 mm and an f-number of k=2.2;

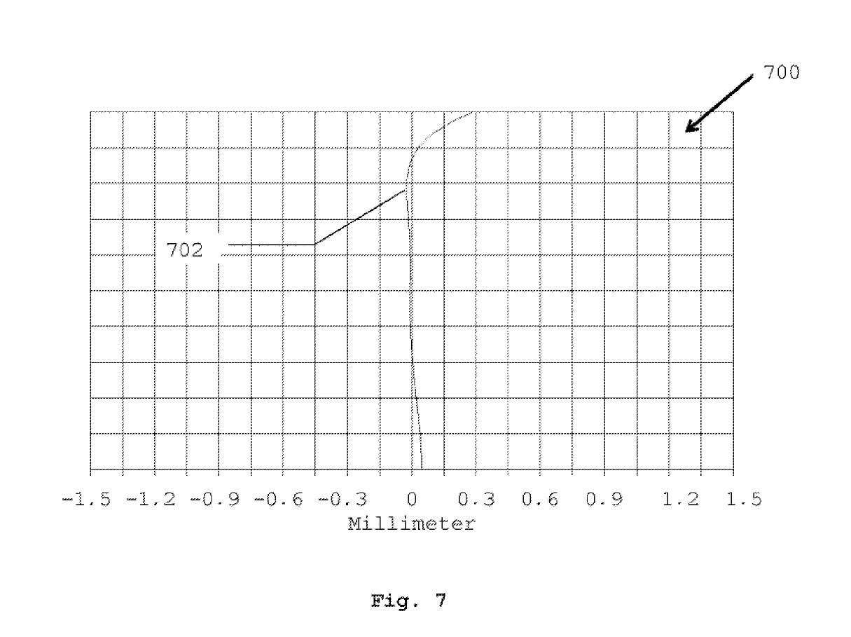

FIG. 7 shows a graphical illustration of the spherical aberration of a wide-angle lens in accordance with FIG. 1 with a focal length of 12 mm and an f-number of k=2.4.

The technical data of three exemplary embodiments of the wide-angle lens illustrated in FIG. 1 are listed in tables 1 to 6. In the tables, specifically:

Table 1 shows a list of the radii, the thicknesses or air clearances, the refractive indexes and the Abbe numbers of a wide-angle lens in accordance with FIG. 1 with a focal length of 16 mm and an f-number of k=2.8;

Table 1A shows a list of the aspherical coefficients of a wide-angle lens in accordance with FIG. 1 with a focal length of 16 mm and an f-number of k=2.8;

Table 2 shows a list of the radii, the thicknesses or air clearances, the refractive indexes and the Abbe numbers of a wide-angle lens in accordance with FIG. 1 with a focal length of 16 mm and an f-number of k=2.2;

Table 2A shows a list of the aspherical coefficients of a wide-angle lens in accordance with FIG. 1 with a focal length of 16 mm and an f-number of k=2.2;

Table 3 shows a list of the radii, the thicknesses or air clearances, the refractive indexes and the Abbe numbers of a wide-angle lens in accordance with FIG. 1 with a focal length of 12 mm and an f-number of k=2.4;

Table 3A shows a list of the aspherical coefficients of a wide-angle lens in accordance with FIG. 1 with a focal length of 12 mm and an f-number of k=2.4.

The exemplary embodiment whose lens element arrangement is illustrated in FIG. 1 schematically shows the basic construction of the compact high-aperture wide-angle lens proposed. All the exemplary embodiments described have the same basic construction, but differ with regard to their focal length and f-number.

In the exemplary embodiment of the optical system 100 as illustrated schematically in FIG. 1, the lens is a high-aperture wide-angle lens 102 having a focal length of 16 mm and an f-number of k=2.8. In the illustration in FIG. 1, the object side 104 is respectively situated on the left, and the image side 106 with the digital acquisition sensor 108 on the right.

The wide-angle lens 102 shown in FIG. 1 consists, in the order as viewed from the object side 104 to the image side 106 or to the image acquisition sensor 108, i.e. from left to right, of the following elements:
a) a first, negative meniscus lens element 112, wherein the convex surface 110 of the meniscus lens element 112 faces the object side 104;
b) a second, positive lens element 118, wherein the more greatly curved convex surface 116 of the lens element 118 faces the object side 104;
c) a diaphragm 122;
d) a third, positive lens element 126,
wherein the more greatly curved convex surface 128 of the lens element 126 faces away from the object side 104;
f) a fourth, negative lens element 130;
g) a fifth, positive meniscus lens element 136, wherein the convex surface 138 of the meniscus lens element 136 faces the object side 104.

The third lens element 126 and the fourth lens element 130 are cemented to one another and form a doublet.

On the image side, a glass path 142 is included downstream of the last lens element 136 of the wide-angle lens 102. Infrared cut filters and/or optical low-pass filters and a sensor cover glass are generally used. The total thickness is between 0.6 mm and 3 mm depending on the manufacturer.

As exemplary embodiments in accordance with the basic construction from FIG. 1, three wide-angle lenses 102 having the following optical characteristic data are presented:

Exemplary embodiment 1:
i. Focal length 16 mm
ii. f-number k=2.8

Exemplary embodiment 2:
i. Focal length 16 mm
ii. f-number k=2.2

Exemplary embodiment 3:
i. Focal length 12 mm
ii. f-number k=2.4

The exact specifications concerning the individual surfaces of the optical elements of the three exemplary embodiments can be found in table 1 to table 3 together with the respectively associated reference numerals.

The lists of the radii, the thicknesses or air clearances, the refractive indexes and Abbe numbers of the three exemplary embodiments can be found in tables 1, 2 and 3.

The aspherical data of the aspherically embodied lens element surfaces of the three wide-angle lenses presented as exemplary embodiments are listed in tables 1A, 2A and 3A.

The surface of an aspherical lens element can generally be described by the following formula:

$$z = \frac{{cr}^{2}}{1 + \sqrt{1 - ( 1 + k ) \cdot {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + …$$

wherein
z is the sagittal (in mm) in the direction of the optical axis.
c indicates the so-called vertex curvature. It serves to describe the curvature of a convex or concave lens element surface and is calculated from the reciprocal of the radius.
r indicates the distance from the optical axis (in mm) and
r is a radial coordinate.
k indicates the so-called cone constant.
a₁, a₂, a₃, a₄, a₅ and a₆ represent the so-called aspherical coefficients, which are the coefficients of a polynomial expansion of the function for describing the surface of the asphere.

During focusing, it is advantageous if, besides shifting the lens as a whole, floating focusing is additionally performed. During floating focusing, the first air space downstream of the diaphragm is reduced. During floating focusing for the closest near setting (β′=−0.1, distance from the object=170 mm), the following values then arise:

| | Air clearance with | |
|---|---|---|
| Reference | respect to the | |
| numeral | closest element/mm | Explanation |
| 104 | 170.000 | The distance between ob- |
| | | ject 104 and first lens |
| | | element surface 114 is a |
| | | minimum of 170 mm. |
| 122 | 4.86 | The air clearance down- |
| | | stream of the diaphragm |
| | | is reduced by 0.3 mm. In |
| | | other words, the rear |
| | | three lens elements are |
| | | jointly shifted in the |
| | | direction of the front |
| | | two lens elements. For |
| | | object distances between |
| | | infinity and 170 mm, |
| | | corresponding interme- |
| | | diate values between 4.86 |
| | | and 5.16 mm arise for |
| | | the air clearance down- |
| | | stream of the diaphragm |
| | | (see table 1). |
| 138 | 21.54 | The image-side vertex |
| | | focal length of the lens |
| | | is lengthened by 1.54 mm |
| | | (see table 1). |

FIGS. 2 to 7 graphically illustrate some characteristic variables of the three exemplary wide-angle lenses 102 in accordance with the basic construction corresponding to FIG. 1.

FIG. 2 graphically shows the image field curvature 200 of a wide-angle lens 102 in accordance with FIG. 1 with a focal length of 16 mm and an f-number of k=2.8. The curve 202 shows the profile of the tangential image shell, while the curve 204 represents the profile of the sagittal image shell. In this case, the horizontal axis (x-axis) indicates the longitudinal defocusing along the optical axis. The vertical axis (y-axis) contains the field coordinate of 0° field angle up to the maximum field angle.

A graphical illustration of the distortion 300 of a wide-angle lens 102 in accordance with FIG. 1 with a focal length of 16 mm and an f-number of k=2.8 is shown in FIG. 3. In this case, the horizontal axis (x-axis) indicates the percentage distortion in the range of −5% to +5%, while the values of the vertical axis (y-axis) correspond to the field coordinates of 0° field angle up to the maximum field angle. The curve 302 represents the profile of the distortion against the field angle up to the maximum field angle. The distortion is always less than 3%.

FIG. 4 graphically reproduces the lateral chromatic aberration of a wide-angle lens 102 in accordance with FIG. 1 with the focal length of 16 mm and an f-number of k=2.8. In this case, the horizontal axis (X-axis) indicates the deviation of the centroid ray from the reference centroid ray at λ=546.074 nm in micrometers. The vertical axis (y-axis) indicates the field coordinate, from 0° field angle up to the maximum field angle. The curve 402 shows the profile of the deviation of the centroid ray from the reference centroid ray for λ=643.8469 nm against the field coordinate, while the curve 404 shows the profile of the deviation of the centroid ray from the reference centroid ray for λ=486.1327 nm against the field coordinate.

The graphical illustration of the spherical aberration 500 of a wide-angle lens 102 having a focal length of 16 mm and an f-number of k=2.8 is shown in FIG. 5, while FIG. 6 illustrates a graphical illustration of the spherical aberration 600 of a wide-angle lens 102 having a focal length of 16 mm and an f-number of k=2.2 and FIG. 7 illustrates the spherical aberration 700 of a wide-angle lens 102 having a focal length of 12 mm and an f-number of k=2.4. The horizontal axis (x-axis) of the diagrams in each case indicates the longitudinal defocusing along the optical axis, and the vertical axis (y-axis) in each case indicates the semidiameter of the entrance pupil of the lens. The diagrams in each case show the longitudinal deviation of an axial aperture ray for different heights of incidence in the entrance pupil, wherein the profile curves 502, 602, 702 were in each case calculated for the wavelength λ=546.074 nm (principal color).

For focal lengths and/or f-numbers other than those already mentioned, all associated dimensional specifications, e.g. radii and air clearances, are scalable in principle.

This makes it possible to realize not only the three examples described, but rather an entire series of lenses of identical type, but with different focal lengths. The wide-angle lens can thus be used for different applications.

### REFERENCE NUMERALS

100 Optical system
102 Wide-angle lens
104 Object side
106 Image side
108 Image sensor
110 First surface of the lens element 112
112 First lens element
114 Second surface of the lens element 112
116 First surface of the lens element 118
118 Second lens element
120 Second surface of the lens element 118
122 Diaphragm
124 First surface of the lens element 126
126 Third lens element
128 Second surface of the lens element 126/first surface of the lens element 130
130 Fourth lens element
132 Second surface of the lens element 130
134 First surface of the lens element 136
136 Fifth lens element
138 Second surface of the lens element 136
140 First surface of the transparent plate 142
142 Transparent plate
144 Second surface of the transparent plate 142
200 Graphical illustration of the image field curvature of a wide-angle lens (focal length 16 mm; f-number k=2.8)
202 Curve profile of the tangential image shell
204 Curve profile of the sagittal image shell
300 Graphical illustration of the distortion of a wide-angle lens (focal length 16 mm; f-number k=2.8)
302 Curve profile of the distortion against the field angle
400 Graphical illustration of the lateral chromatic aberration of a wide-angle lens (focal length 16 mm; f-number k=2.8)
402 Curve profile for the lateral chromatic aberration (deviation of the centroid ray from the reference centroid ray for λ=643.8469 nm against the field coordinate)
404 Curve profile for the lateral chromatic aberration (deviation of the centroid ray from the reference centroid ray for λ=486.1327 nm against the field coordinate)
500 Graphical illustration of the spherical aberration of a wide-angle lens (focal length 16 mm; f-number k=2.8)
502 Curve profile of the longitudinal deviation of an axial aperture ray for different heights of incidence in the entrance pupil
600 Graphical illustration of the spherical aberration of a wide-angle lens (focal length 16 mm; f-number k=2.2)
602 Curve profile of the longitudinal deviation of an axial aperture ray for different heights of incidence in the entrance pupil
700 Graphical illustration of the spherical aberration of a wide-angle lens (focal length 12 mm; f-number k=2.4)
702 Curve profile of the longitudinal deviation of an axial aperture ray for different heights of incidence in the entrance pupil

TABLE 1
Focal length 16 mm/f-number k = 2.8

| | | Thicknesses or | Refractive | Abbe |
|---|---|---|---|---|
| Reference | Radius | air clearances | Index | Number |
| numeral | [mm] | [mm] | n_{d} | ν_{d} |
| 104 | | | | |
| | | INFINITE | | |
| 110* | 11.847 | | | |
| 112 | | 2.19 | 1.81 | 40.7 |
| 114* | 6.043 | | | |
| | | 11.64 | | |
| 116* | 19.720 | | | |
| 118 | | 1.50 | 1.84 | 23.8 |
| 120 | 402.914 | | | |
| | | 0.10 | | |
| 122 | INFINITE | | | |
| | | 5.16 | | |
| 124* | −211.929 | | | |
| 126 | | 2.70 | 1.80 | 46.2 |
| 128 | −8.173 | | | |
| 130 | | 0.80 | 1.84 | 23.8 |
| 132 | −61.395 | | | |
| | | 1.28 | | |
| 134* | −31.727 | | | |
| 136 | | 2.15 | 1.58 | 59.2 |
| 138* | −11.980 | | | |
| | | 20.00 | | |
| 140 | INFINITE | | | |
| | | 3.00 | 1.51 | 64.2 |
| 144 | INFINITE | | | |
| | | 2.17 | | |
| 108 | INFINITE | | | |

*= aspherical surface

TABLE 1A

| Reference Numeral | Aspherical Data | | |
|---|---|---|---|
| 110 | c | 0.084410 | |
| | k | −0.454 | |
| | a₁ | 0 | |
| | a₂ | 7.8717284 | * 10⁻⁶ |
| | a₃ | −2.4056331 | * 10⁻⁷ |
| | a₄ | −3.7458541 | * 10⁻⁹ |
| | a₅ | 2.2696102 | * 10⁻¹¹ |
| 114 | c | 0.165481 | |
| | k | −0.427 | |
| | a₁ | 0 | |
| | a₂ | 6.9145032 | * 10⁻⁵ |
| | a₃ | −7.364305 | * 10⁻⁷ |
| | a₄ | 1.0307366 | * 10⁻⁸ |
| | a₅ | −7.9316523 | * 10⁻¹⁰ |
| 116 | c | 0.050710 | |
| | k | 1.155 | |
| | a₁ | 0 | |
| | a₂ | 3.3694224 | * 10⁻⁵ |
| | a₃ | −1.3559171 | * 10⁻⁶ |
| | a₄ | 5.1635073 | * 10⁻⁷ |
| | a₅ | −2.0385524 | * 10⁻⁸ |
| 124 | c | −0.004719 | |
| | k | −2534.425 | |
| | a₁ | 0 | |
| | a₂ | −7.4750352 | * 10⁻⁵ |
| | a₃ | 5.1635073 | * 10⁻⁷ |
| | a₄ | −2.0385524 | * 10⁻⁸ |
| | a₅ | 1.4435878 | * 10⁻¹⁰ |
| 134 | c | −0.031519 | |
| | k | 1.605 | |
| | a₁ | 0 | |
| | a₂ | −1.1995423 | * 10⁻⁵ |
| | a₃ | 3.6677754 | * 10⁻⁷ |
| | a₄ | 1.8561068 | * 10⁻⁸ |
| | a₅ | 2.4140124 | * 10⁻¹⁰ |
| 138 | c | −0.083472 | |
| | k | −0.412 | |
| | a₁ | 0 | |
| | a₂ | 5.8895935 | * 10⁻⁵ |
| | a₃ | 6.3503954 | * 10⁻⁷ |
| | a₄ | 7.2234339 | * 10⁻⁹ |
| | a₅ | 3.9613491 | * 10⁻¹⁰ |

TABLE 2
Focal length 16 mm/f-number k = 2.2

| | | Thicknesses or | Refractive | Abbe |
|---|---|---|---|---|
| Reference | Radius | air clearances | Index | Number |
| numeral | [mm] | [mm] | n_{d} | ν_{d} |
| 104 | | | | |
| 110* | 12.058 | | | |
| 112 | | 2.24 | 1.81 | 40.7 |
| 114* | 6.150 | | | |
| | | 11.85 | | |
| 116* | 20.070 | | | |
| 118 | | 1.53 | 1.84 | 23.8 |
| 120* | 410.085 | | | |
| | | 1.12 | | |
| 122 | INFINITE | | | |
| | | 4.19 | | |
| 124* | −215.700 | | | |
| 126 | | 2.75 | 1.80 | 46.2 |
| 128 | −8.318 | | | |
| 130 | | 0.81 | 1.84 | 23.8 |
| 132 | −62.487 | | | |
| | | 1.30 | | |
| 134* | −32.291 | | | |
| 136 | | 2.19 | 1.58 | 59.2 |
| 138* | −12.192 | | | |
| 140 | INFINITE | | | |
| | | 3.00 | 1.51 | 64.2 |
| 144 | INFINITE | | | |
| | | 2.17 | | |
| 108 | INFINITE | | | |

*= aspherical surface

TABLE 2A

| Reference Numeral | Aspherical Data | | |
|---|---|---|---|
| 110 | c | 0.082932 | |
| | k | −0.454 | |
| | a₁ | 0 | |
| | a₂ | 7.4659102 | * 10⁻⁶ |
| | a₃ | −2.2025063 | * 10⁻⁷ |
| | a₄ | −3.3106535 | * 10⁻⁹ |
| | a₅ | 1.9363741 | * 10⁻¹¹ |
| 114 | c | 0.162602 | |
| | k | −0.428 | |
| | a₁ | 0 | |
| | a₂ | 6.5580336 | * 10⁻⁵ |
| | a₃ | −6.7424779 | * 10⁻⁷ |
| | a₄ | 9.1098363 | * 10⁻⁹ |
| | a₅ | −6.7670853 | * 10⁻¹⁰ |
| 116 | c | 0.049826 | |
| | k | 1.155 | |
| | a₁ | 0 | |
| | a₂ | 3.1957155 | * 10⁻⁵ |
| | a₃ | −1.2414262 | * 10⁻⁶ |
| | a₄ | 7.038804 | * 10⁻⁸ |
| | a₅ | −1.3286399 | * 10⁻⁹ |
| 120 | c | 0.002439 | |
| | k | 0 | |
| | a₁ | 0 | |
| | a₂ | 0 | |
| | a₃ | 0 | |
| | a₄ | 0 | |
| | a₅ | 3.4126989 | * 10⁻¹⁰ |
| | a₆ | −1.5442384 | * 10⁻¹¹ |
| 124 | c | −0.004636 | |
| | k | −2534 | |
| | a₁ | 0 | |
| | a₂ | −7.0896681 | * 10⁻⁵ |
| | a₃ | 4.7275111 | * 10⁻⁷ |
| | a₄ | −1.8017094 | * 10⁻⁸ |
| | a₅ | 1.2316326 | * 10⁻¹⁰ |
| 134 | c | −0.030968 | |
| | k | 1.605 | |
| | a₁ | 0 | |
| | a₂ | −1.1377012 | * 10⁻⁵ |
| | a₃ | 3.3580758 | * 10⁻⁷ |
| | a₄ | 1.6404608 | * 10⁻⁸ |
| | a₅ | 2.0595743 | * 10⁻¹⁰ |
| 138 | c | −0.082021 | |
| | k | −0.413 | |
| | a₁ | 0 | |
| | a₂ | 5.585962 | * 10⁻⁵ |
| | a₃ | 5.8141808 | * 10⁻⁷ |
| | a₄ | 6.3842014 | * 10⁻⁹ |
| | a₅ | 3.3797229 | * 10⁻¹⁰ |

TABLE 3
Focal length 12 mm/f-number k = 2.4

| | | Thicknesses or | Refractive | Abbe |
|---|---|---|---|---|
| Reference | Radius | air clearances | Index | Number |
| numeral | [mm] | [mm] | n_{d} | ν_{d} |
| 104 | | | | |
| 110* | 8.885 | | | |
| 112 | | 1.64 | 1.80 | 40.7 |
| 114* | 4.532 | | | |
| | | 8.73 | | |
| 116* | 14.790 | | | |
| 118 | | 1.13 | 1.84 | 23.8 |
| 120* | 302.186 | | | |
| | | 0.83 | | |
| 122 | INFINITE | | | |
| | | 3.13 | | |
| 124* | −158.946 | | | |
| 126 | | 2.01 | 1.80 | 46.2 |
| 128 | −6.130 | | | |
| 130 | | 0.60 | 1.84 | 23.8 |
| 132 | −46.046 | | | |
| | | 0.96 | | |
| 134* | −23.795 | | | |
| 136 | | 1.61 | 1.58 | 59.2 |
| 138* | −8.985 | | | |
| | | 20.00 | | |
| 140 | INFINITE | | | |
| | | 3.00 | 1.51 | 64.2 |
| 144 | INFINITE | | | |
| | | 2.17 | | |
| 108 | INFINITE | | | |

*= aspherical surface

TABLE 3A

| Reference Numeral | Aspherical Data | | |
|---|---|---|---|
| 110 | c | 0.112549 | |
| | k | −0.454 | |
| | a₁ | 0 | |
| | a₂ | 1.8658912 | * 10⁻⁵ |
| | a₃ | −1.0137318 | * 10⁻⁶ |
| | a₄ | −2.8062219 | * 10⁻⁸ |
| | a₅ | 3.0227338 | * 10⁻¹⁰ |
| 114 | c | 0.220653 | |
| | k | −0.428 | |
| | a₁ | 0 | |
| | a₂ | 0.00016389933 | |
| | a₃ | −3.1033121 | * 10⁻⁶ |
| | a₄ | 7.7218055 | * 10⁻⁸ |
| | a₅ | −1.0563608 | * 10⁻⁸ |
| 116 | c | 0.067613 | |
| | k | 1.1550 | |
| | a₁ | 0 | |
| | a₂ | 7.9867789 | * 10⁻⁵ |
| | a₃ | −5.7138236 | * 10⁻⁶ |
| | a₄ | 5.9663284 | * 10⁻⁷ |
| | a₅ | −2.0740439 | * 10⁻⁸ |
| 120 | c | 0.003309 | |
| | k | 0 | |
| | a₁ | 0 | |
| | a₂ | 0 | |
| | a₃ | 0 | |
| | a₄ | 0 | |
| | a₅ | 4.2618544 | * 10⁻⁹ |
| | a₆ | −3.5515453 | * 10⁻¹⁰ |
| 124 | c | −0.006291 | |
| | k | −2534 | |
| | a₁ | 0 | |
| | a₂ | −0.00017718602 | |
| | a₃ | 2.1758977 | * 10⁻⁶ |
| | a₄ | −1.5271899 | * 10⁻⁷ |
| | a₅ | 1.9226128 | * 10⁻⁹ |
| 134 | c | −0.042026 | |
| | k | 1.605 | |
| | a₁ | 0 | |
| | a₂ | −2.8433595 | * 10⁻⁵ |
| | a₃ | 1.5455975 | * 10⁻⁶ |
| | a₄ | 1.39051 | * 10⁻⁷ |
| | a₅ | 3.2150529 | * 10⁻⁹ |
| 138 | c | −0.111297 | |
| | k | −0.413 | |
| | a₁ | 0 | |
| | a₂ | 0.00013960518 | |
| | a₃ | 2.6760514 | * 10⁻⁶ |
| | a₄ | 5.4114651 | * 10⁻⁸ |
| | a₅ | 5.2758416 | * 10⁻⁹ |

1. A wide-angle lens for digital image acquisition, comprising the following elements in the stated order, as viewed from the object side:
a) a first, negative meniscus lens element,
wherein the convex surface of the meniscus lens element faces the object side;
b) a second, positive lens element,
wherein the more greatly curved convex surface of the lens element faces the object side;
c) a diaphragm;
d) a third, positive lens element,
wherein the more greatly curved convex surface of the lens element faces away from the object side;
e) a fourth, negative lens element;
f) wherein the third, positive lens element and the fourth, negative lens element are cemented to one another; and
g) a fifth, positive meniscus lens element, wherein the convex surface of the meniscus lens element faces away from the object side;
h) wherein the wide-angle lens has no further lens elements;
i) wherein the surface of the second lens element facing the object has an aspherical surface;
j) wherein at least three lens element surfaces on the object side upstream of the diaphragm and at least three lens element surfaces on the image side downstream of the diaphragm are embodied as aspherical surface; and
k) wherein the refractive indexes n_{d} and Abbe numbers v_{d} of the lens element materials fulfill the conditions according to the table below, wherein all these conditions must be fulfilled simultaneously:

| | Reference numeral | n_{d} | ν_{d} |
|---|---|---|---|
| 1st Lens | 112 | ≧1.8 | ≧40 |
| element | | | |
| 2nd Lens | 118 | ≧1.8 | ≦30 |
| element | | | |
| 3rd Lens | 126 | ≧1.8 | ≧45 |
| element | | | |
| 4th Lens | 130 | ≧1.8 | ≦30 |
| element | | | |
| 5th Lens | 136 | ≧1.5 | ≧55 |
| element | | | |

l) wherein the focal length of the first lens element has a value in the range of −1.0 to −1.2 times the total focal length of the wide-angle lens.

2. The wide-angle lens as claimed in claim 1,
characterized
in that the second, positive lens element and/or the third, positive lens element and/or the fourth, negative lens element are/is a meniscus lens element.

3. The wide-angle lens as claimed in claim 1,
which is embodied in such a way
that focusing can be effected by shifting the entire lens along the optical axis; and/or
that focusing can be effected by varying the distance between the diaphragm and the third, positive lens element.

4. The wide-angle lens as claimed in claim 1,
characterized
in that the air clearance on the image side downstream of the first lens element is at least 0.6 times the total focal length of the wide-angle lens; and
in that the vertex focal length downstream of the last lens element surface in the image-side direction is at least 1.25 times the total focal length of the wide-angle lens.

5. The wide-angle lens as claimed in claim 1,
characterized
in that the fourth lens element is a negative meniscus lens element, wherein the concave surface of the lens element faces the object side.

6. The wide-angle lens as claimed in claim 1,
characterized
in that the first lens element has two aspherical surfaces.

7. The wide-angle lens as claimed in claim 1,
characterized
in that the fifth lens element has two aspherical surfaces.

8. The wide-angle lens as claimed in claim 1,
characterized
in that the image-side surface of the second lens element has one aspherical surface.

9. The wide-angle lens as claimed in claim 1,
characterized
in that the object-side surface of the third lens elements has one aspherical surface.

10. The wide-angle lens as claimed in claim 1,
characterized
in that the ratio of the Abbe numbers of the third lens element to the Abbe number of the fourth lens element is a value greater than or equal to 1.5.
